(19) United States
(12) Patent Application Publication
(10) Pub. No.: US 2026/0159131 A1
(43) Pub. Date: Jun. 11, 2026

(54) SYSTEMS AND METHODS FOR PREDICTING PROBABILITIES OF AN UNEXPECTED HAZARD DURING VEHICLE TRAVEL

(71) Applicant: Toyota Motor Engineering & Manufacturing North America, Inc., Plano, TX (US)

(72) Inventor: Michael Allen Clifford, Mountain View, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/973,305

(22) Filed: Dec. 9, 2024

(51) Int. Cl. B60W 60/00; B60W 50/06

(52) U.S. Cl. CPC B60W 60/0015; B60W 50/06; B60W 2420/408; B60W 2554/4041

(57) ABSTRACT

Systems, methods, and other embodiments described herein relate to a learning model predicting event and behavior probabilities for an unexpected hazard using sensor data and a location profile along a planned path involving a vehicle. In one embodiment, a method includes acquiring sensor data and a location profile about a hazard on a road by a vehicle. The method also includes predicting an event probability and a behavior probability by a learning model for the hazard using the sensor data and the location profile about an area. The method also includes adapting a trajectory of the vehicle by a planning model using the event probability and the behavior probability.

### TECHNICAL FIELD

The subject matter described herein relates, in general, to predicting an unexpected hazard for vehicle travel, and, more particularly, to predicting probabilities about characteristics associated with the unexpected hazard that is dynamic using a location profile during the vehicle travel.

### BACKGROUND

Automated vehicles (AV) navigate a path automatically using various approaches. For example, a road vehicle moving between two points plans a route using an input model that obeys restrictions such as lane keeping, speed limits, etc. The road vehicle then attempts to follow the planned path. A perception system of the road vehicle can detect and avoid objects that are obstacles while following the planned path for safety. However, the perception system may be unable to avoid obstacles having dynamic properties from limited data. As such, travel safety can be compromised when the AV avoids static obstacles but encounters dynamic obstacles along the planned path.

In various implementations, systems tracking dynamic obstacles for vehicles face difficulties when mainly relying upon sensor data. For instance, systems predicting obstacles along a planned path for a vehicle lack the capability to identify future events using sensor data. As an example, a system predicts current traffic movement on the road without estimating events such as animals suddenly entering the road. Furthermore, warning systems can fail to anticipate atypical motion by objects that become obstacles when an operator is manually controlling a vehicle. Accordingly, systems predicting near-present and major obstacles without factoring future obstacles along a planned path can limit safety capabilities.

### SUMMARY

In one embodiment, example systems and methods relate to a learning model predicting event and behavior probabilities for an unexpected hazard using sensor data and a location profile along a planned path involving a vehicle. In various implementations, an automated vehicle (AV) (e.g., a road vehicle, a drone, an autonomous boat, etc.) tracks objects that move, drive, walk, etc., through estimating current positions and velocities. The AV can avoid collisions with objects that are hazards by predicting trajectories using a current velocity estimated with a perception system. However, the AV may demand more than the current velocity to predict a short-term behavior associated with certain objects that are hazardous obstacles. For example, a child suddenly entering a road can exhibit atypical motion that makes path planning increasingly complex. Furthermore, the AV can miss object presence due to sensor errors or insufficient capabilities associated with inferring future presence. Similarly, a vehicle manually controlled by an operator can collide with hazardous obstacles that warning systems fail to anticipate along the road. As such, systems making predictions about obstacle presence and behavior for avoiding hazards face challenges during vehicle travel, particularly involving future hazards.

Therefore, in one embodiment, a prediction system assists an AV with avoiding hazardous events and objects in the future that is currently unperceivable and unexpected. In particular, the prediction system can include a learning model (e.g., a neural network) that estimates event and behavior probabilities for a hazard that is dynamic at a specific location, date, time-of-day, etc. The learning model can compute probabilities using acquired sensor data from the AV and a location profile. Here, the behavior probability for a particular motion occurring for an object near the AV is computed using model weights. This allows systems to gauge the extent of the object becoming an obstacle unexpectedly. For example, the prediction system estimates probabilities for a scenario that children are likely to enter a road when school ends during the fall months. As such, a planning model of the AV can avoid an anticipated emergency through altering a trajectory using the estimated event and behavior probabilities for the scenario outputted from the learning model. Accordingly, the prediction system helps an AV safely navigate a hazard through estimating probabilities for anticipating emergencies using the learning and planning models.

In one embodiment, a prediction system having a learning model that predicts event and behavior probabilities about an unexpected hazard using sensor data and a location profile along a planned path involving a vehicle is disclosed. The prediction system includes a memory storing instructions that, when executed by a processor, cause the processor to acquire sensor data and a location profile about a hazard on a road by a vehicle. The instructions also include instructions to predict an event probability and a behavior probability by a learning model for the hazard using the sensor data and the location profile about an area. The instructions also include instructions to adapt a trajectory of the vehicle by a planning model using the event probability and the behavior probability.

In one embodiment, a non-transitory computer-readable medium for a learning model predicting event and behavior probabilities for an unexpected hazard using sensor data and a location profile along a planned path involving a vehicle and including instructions that when executed by a processor cause the processor to perform one or more functions is disclosed. The instructions include instructions to acquire sensor data and a location profile about a hazard on a road by a vehicle. The instructions also include instructions to predict an event probability and a behavior probability by a learning model for the hazard using the sensor data and the location profile about an area. The instructions also include instructions to adapt a trajectory of the vehicle by a planning model using the event probability and the behavior probability.

In one embodiment, a method for a learning model predicting event and behavior probabilities for an unexpected hazard using sensor data and a location profile along a planned path involving a vehicle is disclosed. In one embodiment, the method includes acquiring sensor data and a location profile about a hazard on a road by a vehicle. The method also includes predicting an event probability and a behavior probability by a learning model for the hazard using the sensor data and the location profile about an area. The method also includes adapting a trajectory of the vehicle by a planning model using the event probability and the behavior probability.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a prediction system that is associated with predicting probabilities about characteristics associated with a dynamic hazard during vehicle travel.

FIG. 3 illustrates an example of identifying unexpected hazards around the vehicle with a learning model using sensor data and a location profile.

FIG. 4 illustrates one embodiment of a method that is associated with predicting behavior and event probabilities for an unexpected hazard using the sensor data from the vehicle and the location profile by the learning model.

### DETAILED DESCRIPTION

Systems, methods, and other embodiments associated with a learning model predicting event and behavior probabilities for an unexpected hazard using sensor data and a location profile along a planned path involving a vehicle are disclosed herein. In various implementations, an automated vehicle (AV) (e.g., a road vehicle, a drone, an autonomous boat, etc.) can avoid collisions along a path through motion tracking of objects using estimated patterns and velocities. For example, the AV uses outputs from a perception system to identify short-term patterns of objects that are potentially hazardous. However, the perception system may misidentify unseen events such as a domestic animal (e.g., a cat) suddenly crossing a road due to erratic qualities. The perception system may also focus detections on existing objects within a field-of-view and fail to predict unexpected and future events. Thus, systems mitigating collisions along a path encounter challenges with predicting future hazards and unexpected events.

Therefore, in one embodiment, a prediction system estimates event and behavior probabilities for future hazards that are unexpected using a learning model about an area. In particular, a vehicle implements the learning model (e.g., a neural network (NN)) to estimate the probabilities using acquired sensor data and a location profile about a road and objects within the area. In one approach, an event probability represents a future event or a near-term event for an unexpected hazard involving the objects at a particular time-of-day. Furthermore, the behavior probability can indicate a likelihood for a particular motion occurring and a degree of the particular motion associated with the unexpected hazard. For instance, a perception prediction using the sensor data indicates a ball on the road and the behavior probability weighs that a child retrieving the ball travels a minimal distance from a sidewalk and hastily leaves the road. As such, a planning model (e.g., a path generator) of the vehicle can adapt a trajectory by maneuvering around the ball within a lane and returns back into the lane, thereby avoiding a greater disturbance to traffic while avoiding an unexpected collision with the child.

In various implementations, the prediction system trains the learning model through accumulating information and a location profile associated with the area and a time period. For instance, the information is crowdsourced data that a server acquires for the prediction system. Similarly, the information can be fleet data from vehicles traveling a particular area during a time-of-day, date, event, etc. Here, the location profile can reflect obstructed objects, characteristics about local objects, motion risks associated with live objects, etc., about an area. In one approach, the learning model trains using the information to estimate the event probability during particular dates. Furthermore, the training can involve weighing different motions for particular objects (e.g., deer) among an area for estimating the behavior probability during implementation. Therefore, the prediction system reduces collisions and increases safety through training a learning model to estimate behavior and event probabilities for an unexpected hazard using sensor data and a location profile.

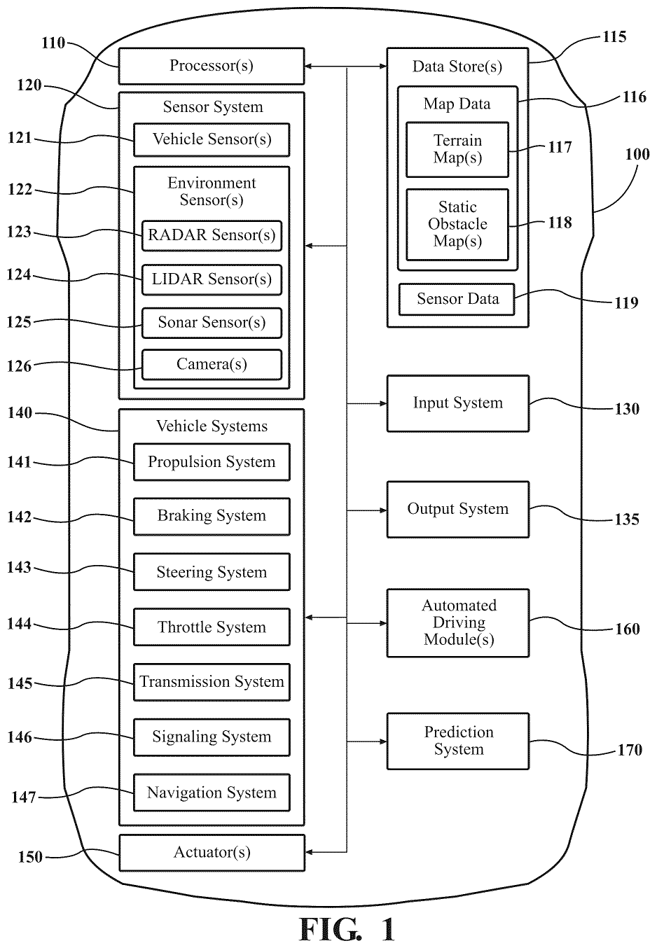

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. For instance, a vehicle is one of an automated vehicle, an automated drone, an automated water vehicle, an aircraft, and a motor vehicle. Furthermore, in some implementations, a prediction system 170 uses road-side units (RSU), consumer electronics (CE), mobile devices, an augmented reality (AR) device, robots, drones, and so on that benefit from the functionality discussed herein associated with a learning model predicting event and behavior probabilities for an expected hazard using sensor data and a location profile along a planned path involving a vehicle.

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances. For example, one or more components of the disclosed system can be implemented within a vehicle while further components of the system are implemented within a cloud-computing environment or other system that is remote from the vehicle 100.

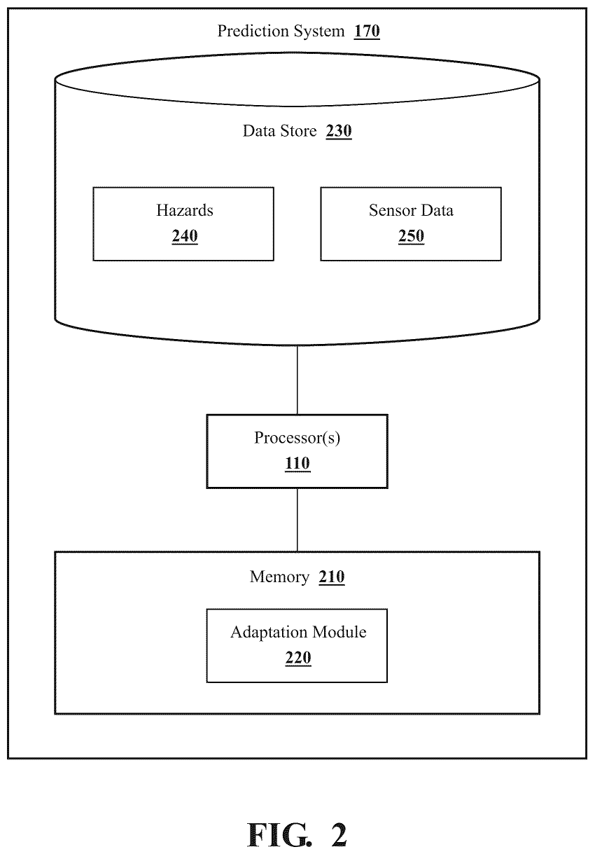

Some of the possible elements of the vehicle 100 are shown in FIG. 1 and will be described along with subsequent figures. However, a description of many of the elements in FIG. 1 will be provided after the discussion of FIGS. 2-4 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes a prediction system 170 that is implemented to perform methods and other functions as disclosed herein relating to a learning model predicting event and behavior probabilities for an unexpected hazard using sensor data and a location profile along a planned path involving a vehicle. As will be discussed in greater detail subsequently, the prediction system 170, in various embodiments, is implemented partially within the vehicle 100, and as a cloud-based service. For example, in one approach, functionality associated with at least one module of the prediction system 170 is implemented within the vehicle 100 while further functionality is implemented within a cloud-based computing system.

With reference to FIG. 2, one embodiment of the prediction system 170 of FIG. 1 is further illustrated. The prediction system 170 is shown as including a processor(s) 110 from the vehicle 100 of FIG. 1. Accordingly, the processor(s) 110 may be a part of the prediction system 170, the prediction system 170 may include a separate processor from the processor(s) 110 of the vehicle 100, or the prediction system 170 may access the processor(s) 110 through a data bus or another communication path. In one embodiment, the prediction system 170 includes a memory 210 that stores an adaptation module 220. The memory 210 is a random-access memory (RAM), a read-only memory (ROM), a hard-disk drive, a flash memory, or other suitable memory for storing the adaptation module 220. The adaptation module 220 is, for example, computer-readable instructions that when executed by the processor(s) 110 causes the processor(s) 110 to perform the various functions disclosed herein.

The prediction system 170 as illustrated in FIG. 2 is generally an abstracted form. Furthermore, the prediction system 170 generally includes instructions that function to control the processor(s) 110 to receive data inputs from one or more sensors of the vehicle 100. The inputs are, in one embodiment, observations of one or more objects in an environment proximate to the vehicle 100 and/or other aspects about the surroundings. As provided for herein, the prediction system 170, in one embodiment, acquires sensor data 250 that includes at least camera images. In further arrangements, the prediction system 170 acquires the sensor data 250 from further sensors such as radar sensors 123, LIDAR sensors 124, and other sensors as may be suitable for identifying vehicles and locations of the vehicles.

Accordingly, the prediction system 170 in one embodiment controls the respective sensors to provide the data inputs in the form of the sensor data 250. Additionally, while the prediction system is discussed as controlling the various sensors to provide the sensor data 250, in one or more embodiments, the prediction system 170 can employ other techniques to acquire the sensor data 250 that are either active or passive. For example, the prediction system passively sniffs the sensor data 250 from a stream of electronic information provided by the various sensors to further components within the vehicle 100. Moreover, the prediction system 170 can undertake various approaches to fuse data from multiple sensors when providing the sensor data 250 and/or from sensor data acquired over a wireless communication link. Thus, the sensor data 250, in one embodiment, represents a combination of perceptions acquired from multiple sensors.

In addition to locations of surrounding vehicles, the sensor data 250 includes, for example, information about lane markings, and so on. Moreover, the prediction system 170 can control the sensors to acquire the sensor data 250 about an area that encompasses 360 degrees about the vehicle 100 in order to provide a comprehensive assessment of the surrounding environment. Of course, in alternative embodiments, the prediction system 170 acquires the sensor data 250 about a forward direction alone when, for example, the vehicle 100 is not equipped with further sensors to include additional regions about the vehicle and/or the additional regions are not scanned due to other reasons.

Moreover, in one embodiment, the prediction system 170 includes a data store 230. In one embodiment, the data store 230 is a database. The database is, in one embodiment, an electronic data structure stored in the memory 210 or another data store and that is configured with routines that can be executed by the processor(s) 110 for analyzing stored data, providing stored data, organizing stored data, and so on. Thus, in one embodiment, the data store 230 stores data used by the adaptation module 220 in executing various functions. In one embodiment, the data store 230 includes the sensor data 250 along with, for example, metadata that characterize various aspects of the sensor data 250. For example, the metadata can include location coordinates (e.g., longitude and latitude), relative map coordinates or tile identifiers, time/date stamps from when the separate sensor data 250 was generated, and so on. In one embodiment, the data store 230 further includes the hazards 240 that includes animals, children, pedestrians, vehicles, etc., that risks collisions and dangerous scenarios involving the vehicle 100. The hazards 240, in one approach, are associated with an emergency caused by an object.

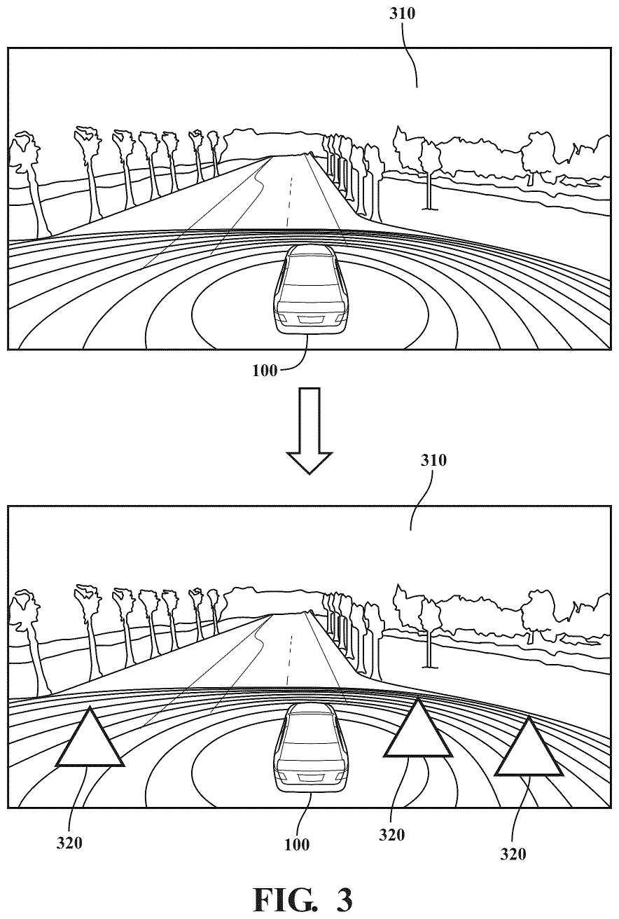

Now turning to FIG. 3, an example of identifying unexpected hazards around the vehicle 100 with a learning model using the sensor data 250 and a location profile is illustrated. In various implementations, the prediction system 170 includes instructions that cause the processor 110 to acquire the sensor data 250 and a location profile about a hazard on a road by the vehicle 100. Here, the location profile can include information about one of obstructed objects, hidden objects, characteristics about local objects, motion risks associated with live objects, and motion variance associated with the local objects. Furthermore, the prediction system 170 can predict an event probability and a behavior probability by a learning model for the hazard using the sensor data 250 and the location profile about an area. In one approach, the adaptation module 220 adapts a trajectory of the vehicle 100 with a planning model that generates various paths using the event probability and the behavior probability.

In various implementations, the prediction system 170 uses a machine learning algorithm for the learning model, such as a NN, a convolutional neural network (CNN), to perform semantic segmentation over the sensor data 250 from which further information is derived. Of course, in further aspects, the prediction system 170 may employ different machine learning algorithms or implement different approaches for performing the associated functions, which can include deep convolutional encoder-decoder architectures, or another suitable approach that generates semantic labels for the separate object classes represented in the image. Whichever particular approach the prediction system 170 implements, the learning model can provide an output with semantic labels identifying objects represented in the sensor data 250. In this way, the prediction system 170 can estimate unexpected hazards through computed event and behavior probabilities associated with identified objects.

Regarding details about acquiring the sensor data 250 and the location profile about a hazard, the vehicle 100 can form the sensor data 250 when traversing a specific area 310 for a time duration (e.g., a day), a specific time (e.g., a season, a holiday, etc.), etc. This can include the prediction system 170 collecting the sensor data 250 from multiple vehicles (e.g., a fleet) similar to the vehicle 100. Furthermore, an event can be associated with a specific location (e.g., a school) within the specific area 310 (e.g., a residential neighborhood), at the specific time, a specific behavior, etc., for an object within the vicinity of the vehicle 100. The location profile can reflect obstructed objects, characteristics about local objects, motion risks associated with live objects, etc., about an area. In this way, an object may be included as the hazards 240 according to the sensor data 250 and the location profile.

In one embodiment, the prediction system 170 infers event and behavior probabilities associated with one of the hazards 240 using the learning model. In particular, objects 320 may be hazards that are collision risks for the vehicle 100 and displayed within the specific area 310 using output system 135. The vehicle 100 can perceive the objects 320 along a trajectory that are hazardous and non-hazardous using a perception system. In one approach, the perception system is sensors and a classification model that identifies objects represented in data from the sensors. Here, the prediction system 170 can train the learning model with accumulated information including the sensor data 250 and location profiles associated with the area online, offline, etc., to infer the probabilities. As previously explained, the information can be one of crowdsourced data, fleet data, etc., and temporally associated with the area (e.g., a time-of-day, season, date, etc.) for accurately predicting atypical events and relevant behavior probabilities. For example, the learning model trains to estimate an event probability for an object at a date. The behavior probability weighs motions likely occurring by the object for a specific area and/or the date, the time-of-day, etc. Furthermore, a weight can be a parameter of the learning model adjusting for events and behavior objects. For instance, the weight factors that the vehicle 100 avoids children haphazardly running into the street by switching to a left lane near a school. Still, the weight can factor the vehicle 100 hitting a child in general near the school.

Moreover, the event probability can represent one of typical, unexpected, and atypical events for objects within the location profile. Additionally, the event probability can represent one of a future event, a near-term event, and an upcoming event associated with the hazard, and the event probability is associated with a time-of-day. In this way, the learning model identifies future obstructions and hazards that can cause collisions involving the vehicle 100 through model training.

Further examples of the prediction system 170 estimating events and behavior probabilities can involve the following. The learning model can output an event and behavior probability about a street block including a school associated with the specific area 310 of North America. In particular, there is a 60 percent probability that at 2:45 PM in October a child will run onto the street away from a cross-walk that forms a location profile. Here, the event can be a child running onto a street within a school zone perceived using the sensor data 250. The behavior probability can be that the child enters the street away from the cross-walk. In this way, the learning model predicts probabilities using the sensor data 250 and the location profile involving a school zone during a time-of-day.

Moreover, the same street block can have a 20 percent probability in July during summer break associated with a different location profile. In another example, the learning model outputs a 70 percent probability that a trailing vehicle will aggressively change lanes and pass the vehicle 100 when the trailing vehicle is behind the vehicle 100 at a distance less than a distance threshold (e.g., 5 meters). Besides distance, the prediction system 170 can factor a time duration (e.g., 10 seconds) being greater than a time threshold (e.g., 5 seconds) along with satisfying the distance threshold. After passing the vehicle 100, in one approach, the learning model predicts a 50 percent probability that the trailing vehicle returns to the lane at a distance less than a second distance threshold. In this way, the vehicle 100 can adapt safety systems using the event and behavior probabilities.

Another traffic scenario can involve the vehicle 100 backing out from a parking spot at nighttime. Here, the predicted event probability can involve a bicyclist traveling in a parking lot during nighttime. The predicted behavior probability can indicate a percentage chance that the bicyclist accelerates to pass the vehicle 100 before the vehicle 100 completely backs out. Furthermore, the prediction system 170 can quantify event and behavior probabilities when the vehicle 100 turns left at an intersection with an obstructed view of oncoming traffic during inclement weather. For example, the oncoming traffic can be traveling on the far-right lane. The obstructed view can be caused by another vehicle turning left and blocking the view of the vehicle 100. As such, the prediction system 170 outputs that the vehicle 100 will be unable to turn at the intersection before oncoming traffic representing a hazardous event. Additionally, the prediction system 170 can indicate that a vehicle from the oncoming traffic will continue at the current speed and collide with the rear of the vehicle 100.

A traffic scenario can also involve animals. Here, for instance, the predicted event probability can be an atypical event involving deer traveling on a road within the specific area 310. The predicted behavior probability can indicate a percentage chance that the deer comes onto the road and include a time period during which the deer likely remains on the road. Furthermore, other embodiments involve the vehicle 100 being a boat where the predicted event probability can be a water skier crossing a path. The predicted behavior probability can indicate a percentage chance that the water skier crosses perpendicular to the boat within a distance threshold (e.g., 20 meters). The vehicle 100 may also be an airplane traveling on a tarmac. For instance, the airplane is on a runaway and soon to taxi. The predicted event probability can be a servicing truck traveling in taxi lanes. Such encounters can be typical for airports having self-managed tarmacs. The predicted behavior probability can indicate a percentage chance the servicing truck erroneously crosses into the runway.

In one approach, the adaptation module 220 generates a trajectory by a planning model

using behavior and event probabilities. For instance, the learning model outputs an elevated probability that a trailing vehicle will aggressively change lanes and pass the vehicle 100. In response, the adaptation module 220 may command that the vehicle 100 change paths and move right to allow the trailing vehicle to pass. A command can be one of a steering command, a braking command, and an acceleration command outputted by automated driving module(s) 160, a model predictive command (MPC), etc. The adaptation module 220 can also warn an operator about the objects 320 being or becoming the hazards 240 and suggest changing the trajectory, such through prompts (e.g., audible, visual, etc.). Additionally, this scenario can involve the trajectory being part of a planned path generated by the navigation system 147.

In another embodiment, the learning model is included in the adaptation module 220 for changing a trajectory of the vehicle 100 to avoid an anticipated emergency through factoring the event and behavior probabilities. Integrating the learning model with the adaptation module 220 can increase adjustment speeds that allows granular adaptation, such as performing different adaptations at different road segments along the trajectory. Additionally, integrating the learning model with the adaptation module 220 can enable the vehicle 100 to perform a trajectory change and avoid an anticipated emergency with a greater time amount than possible without the emergency prediction. Consequently, the vehicle 100 can have a wider array of actions (e.g., braking, changing one or more lanes, slowing speed for avoiding a predicted emergency, etc.) than without the prediction. This increase in potential adaptations and time for the adaptations allows the vehicle 100 to select adaptations that result in safer outcomes than possible if sufficient time were unavailable to select and carry out the adaptations.

The adaptation module 220 can generate and adjust a trajectory (e.g., a route) using an environment model for avoiding objects that may become potential obstacles, hazards, etc. Here, a perception system having a vision model (e.g., a CNN, a region-based CNN (R-CNN), U-net, etc.) can form the environment model using information from the sensor data 250, the input system 130, etc. In one approach, the environment model reflects a live state about vehicle perception using the union of current inputs. For example, the union identifies relationships between the current sensor data 250 and potential obstacles from the hazards 240. Accordingly, the prediction system 170 adapts trajectories according to estimated event and behavior probabilities for a hazard using the sensor data 250 and the location profile.

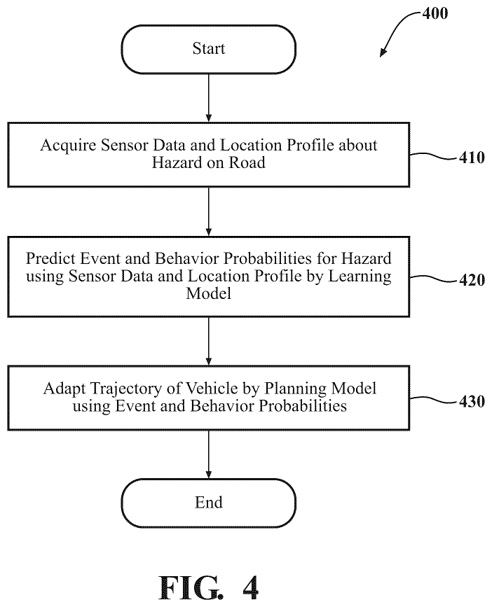

Now turning to FIG. 4, a flowchart of a method 400 that is associated with a learning model predicting event and behavior probabilities for an unexpected hazard using the sensor data 250 and a location profile along a planned path involving the vehicle 100 is illustrated. Method 400 will be discussed from the perspective of the prediction system 170 of FIGS. 1 and 2. While the method 400 is discussed in combination with the prediction system 170, it should be appreciated that the method 400 is not limited to being implemented within the prediction system 170 but is instead one example of a system that may implement the method 400.

At 410, the prediction system 170 acquires the sensor data 250 and a location profile about a hazard on a road. As previously explained, the vehicle 100 can form the sensor data 250 when traversing a specific area. The sensor data 250 can be captured during a time, specific time, a season, etc., associated with the specific area. In one approach, the vehicle 100 and the prediction system 170 collect the sensor data 250 from multiple vehicles (e.g., a fleet). In one approach, an event where the vehicle 100 encounters an object is associated with a specific location within the specific area and the prediction system 170 tags the object for the specific time, a specific behavior, etc. Regarding the location profile, this information can reflect obstructed objects, characteristics about local objects, motion risks associated with live objects, etc., about an area.

At 420, the prediction system 170 predicts event and behavior probabilities for a hazard using the sensor data 250 and the location profile by a learning model (e.g., a NN, a CNN, etc.). Here, objects along a trajectory may be hazards that increase collision risks for the vehicle 100. Such objects can be associated with a particular area and displayed using the output system 135 for increasing operator safety and awareness. In one approach, the vehicle 100 perceives objects along the trajectory that are hazardous and non-hazardous using a perception system (e.g., a vision model). Furthermore, the predicted event probability can represent one of typical, unexpected, and atypical events for objects within the location profile. In another approach, the event probability represents one of a future event, a near-term event, and an upcoming event associated with the hazard, and the event probability is associated with a time-of-day.

Moreover, the event and behavior probabilities can improve downstream tasks for the vehicle 100 during travel scenarios that vary. For instance, the learning model outputs an increased likelihood that a trailing vehicle tailgating will change lanes and pass the vehicle 100 that represents an event. The behavior probability can factor the trailing vehicle being behind the vehicle 100 at a distance less than a distance threshold. In another approach, the prediction system 170 can factor a time duration greater than a time threshold along with satisfying the distance threshold. As additional insight, the learning model predicts an increased probability that the trailing vehicle returns to the lane at a distance less than a second distance threshold after passing the vehicle 100. As such, downstream tasks by safety systems, automated driving, etc., can intelligently adapt using the event and behavior probabilities.

At 430, the adaptation module 220 adapts a trajectory of the vehicle 100 by a planning model using the event and behavior probabilities. Here, in one embodiment, vehicle 100 executes tasks using outputs from the learning model. For example, the adaptation module 220 commands that the vehicle 100 change paths when the learning model outputs an elevated probability that a trailing vehicle will aggressively change lanes and pass the vehicle 100. As such, a trajectory adjusts from traveling straight to slowly moving right, thereby allowing the trailing vehicle to pass. A command can be one of a steering command, a braking command, and an acceleration command outputted by automated driving module(s) 160, a MPC, etc., that is actively controlling or passively directing the vehicle 100. The adaptation can also be passively triggered through warning an operator using prompts (e.g., audible, visual, etc.) about the objects as potential hazards 240 and suggest changing the trajectory. Another task adjustment for a passive activity can involve the trajectory being part of a planned path generated with the navigation system 147. For instance, the task adjustment suggests alternate routes for a travel plan that avoids the hazards 240 identified by the prediction system 170. Therefore, the prediction system 170 increases safety through a learning model that estimates event and behavior probabilities for a hazard and a planning model adapting a vehicle trajectory using the event and behavior probabilities.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., category 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, programmable read-only memory (PROM), erasable programmable read-only memory (EPROM), electrically erasable programmable read-only memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, cross-walks, curbs proximate to the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or one or more cameras 126. In one or more arrangements, the one or more cameras 126 can be high dynamic range (HDR) cameras, stereo, or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include an output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the prediction system 170, and/or the automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the movement of the vehicle 100. The processor(s) 110, the prediction system 170, and/or the automated driving module(s) 160 may control some or all of the vehicle systems 140 and, thus, may be partially or fully autonomous as defined by the society of automotive engineers (SAE) levels 0 to 5.

The processor(s) 110, the prediction system 170, and/or the automated driving module(s) 160 can be operatively connected to communicate with the various vehicle systems 140 and/or individual components thereof. For example, the processor(s) 110, the prediction system 170, and/or the automated driving module(s) 160 can be in communication to send and/or receive information from the various vehicle systems 140 to control the movement of the vehicle 100. The processor(s) 110, the prediction system 170, and/or the automated driving module(s) 160 may control some or all of the vehicle systems 140.

The processor(s) 110, the prediction system 170, and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110, the prediction system 170, and/or the automated driving module(s) 160 can control the direction and/or speed of the vehicle 100. The processor(s) 110, the prediction system 170, and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the prediction system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A prediction system comprising:
a memory storing instructions that, when executed by a processor, cause the processor to:
acquire sensor data and a location profile about a hazard on a road by a vehicle;
predict an event probability and a behavior probability by a learning model for the hazard using the sensor data and the location profile about an area; and
adapt a trajectory of the vehicle by a planning model using the event probability and the behavior probability.

2. The prediction system of claim 1 further including instructions to cause the processor to:
accumulate information for the sensor data and the location profile associated with the area and a time period, the information being one of crowdsourced data and fleet data; and
train the learning model using the information to estimate the event probability for a date and the behavior probability that weights a particular motion occurring associated with objects among the area.

3. The prediction system of claim 1 further including instructions to cause the processor to:
perceive objects along the trajectory without the hazard by a perception system of the vehicle.

4. The prediction system of claim 1, wherein the event probability represents one of a future event, a near-term event, and an upcoming event associated with the hazard, and the event probability is associated with a time-of-day.

5. The prediction system of claim 1 further including instructions to cause the processor to:
generate the trajectory and control the vehicle by the planning model using an environmental model that factors obstacles by identifying a union among the sensor data and the obstacles include the hazard.

6. The prediction system of claim 1, wherein the hazard is associated with an emergency and the event probability represents one of typical and atypical events for objects within the location profile.

7. The prediction system of claim 1, wherein the sensor data includes one of images and light detection and ranging (LIDAR) data and the location profile includes one of obstructed objects, hidden objects, characteristics about local objects, motion risks associated with live objects, and motion variance associated with the local objects.

8. The prediction system of claim 1, wherein the vehicle is one of an automated vehicle, an automated drone, an automated water vehicle, an aircraft, and a motor vehicle.

9. A non-transitory computer-readable medium comprising:
instructions that when executed by a processor cause the processor to:
acquire sensor data and a location profile about a hazard on a road by a vehicle;
predict an event probability and a behavior probability by a learning model for the hazard using the sensor data and the location profile about an area; and
adapt a trajectory of the vehicle by a planning model using the event probability and the behavior probability.

10. The non-transitory computer-readable medium of claim 9 further including instructions to cause the processor to:
accumulate information for the sensor data and the location profile associated with the area and a time period, the information being one of crowdsourced data and fleet data; and
train the learning model using the information to estimate the event probability for a date and the behavior probability that weights a particular motion occuring associated with objects among the area.

11. The non-transitory computer-readable medium of claim 9 further including instructions to cause the processor to:
perceive objects along the trajectory without the hazard by a perception system of the vehicle.

12. The non-transitory computer-readable medium of claim 9, wherein the event probability represents one of a future event, a near-term event, and an upcoming event associated with the hazard, and the event probability is associated with a time-of-day.

13. A method comprising:
acquiring sensor data and a location profile about a hazard on a road by a vehicle;
predicting an event probability and a behavior probability by a learning model for the hazard using the sensor data and the location profile about an area; and
adapting a trajectory of the vehicle by a planning model using the event probability and the behavior probability.

14. The method of claim 13 further comprising:
accumulating information for the sensor data and the location profile associated with the area and a time period, the information being one of crowdsourced data and fleet data; and
training the learning model using the information to estimate the event probability for a date and the behavior probability that weights a particular motion occurring associated with objects among the area.

15. The method of claim 13 further comprising:
perceiving objects along the trajectory without the hazard by a perception system of the vehicle.

16. The method of claim 13, wherein the event probability represents one of a future event, a near-term event, and an upcoming event associated with the hazard, and the event probability is associated with a time-of-day.

17. The method of claim 13 further comprising:
generating the trajectory and controlling the vehicle by the planning model using an environmental model that factors obstacles by identifying a union among the sensor data and the obstacles include the hazard.

18. The method of claim 13, wherein the hazard is associated with an emergency and the event probability represents one of typical and atypical events for objects within the location profile.

19. The method of claim 13, wherein the sensor data includes one of images and light detection and ranging (LIDAR) data and the location profile includes one of obstructed objects, hidden objects, characteristics about local objects, motion risks associated with live objects, and motion variance associated with the local objects.

20. The method of claim 13, wherein the vehicle is one of an automated vehicle, an automated drone, an automated water vehicle, an aircraft, and a motor vehicle.
